(19) United States
(12) Patent Application Publication
(10) Pub. No.: US 2007/0156491 A1
(43) Pub. Date: Jul. 5, 2007

(54) Method and system for request processing in a supply chain

(76) Inventors: Francesca Schuler, Des Plaines, IL (US); Thomas S. Babin, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 11/323,546

(22) Filed: Dec. 30, 2005

(51) Int. Cl. G06F 9/46

(52) U.S. Cl. 705/8

(57) ABSTRACT

A method and a decentralized system for processing an order request for a resource are provided. An order request is processed in a decentralized system device (202) of the decentralized system (108). The decentralized system includes at least one operator device, and at least one pallet with an associated wireless pallet device. The method includes receiving (302) the order request for a set of resources. The method further includes obtaining (304) resource information pertaining to the set of resources from a resource information database. Further, a pallet configuration is optimized (306) based on the resource information and the pallet configuration is wirelessly communicated (308) to the at least one pallet device and/or the at least one operator device.

### RELATED APPLICATION

This application is related to U.S. patent application Ser. No. ______, attorney docket number CML02553T, entitled “Method for Resource Management in a Supply Chain”, filed on the same day hereof, and assigned to the assignee hereof.

### FIELD OF THE INVENTION

The present invention relates to the field of supply chain management, and more specifically, to processing an order request in a supply chain.

### BACKGROUND

Supply chain management is a process of planning, implementing, and controlling the operations of a supply chain. A supply chain is a process or series of processes for providing one or more resources or products to customers. For example, the supply chain may include the procurement of raw material or the procurement of component parts, the manufacture of products, distribution of products or services, inventory management, and product sales. The supply chain may exist entirely within a single organization or may operate within a number of organizations. Effective implementation of the supply chain makes a business enterprise competitive. Business enterprises generally use computer-implemented management systems to model supply chains and generate plans to provide resources to customers.

Inventory management is an essential part of a supply chain. There are various management systems through which resources in an inventory are managed. For example, a centralized system has a central controller to keep track of the resources. The central controller communicates with the resources at frequent time intervals to check their status. To detect the exact status of the resources at any given point of time, the central controller frequently queries the various components of the inventory management system. Examples of components of the inventory management system include processors, sensors, databases, and so forth. These components of the inventory management system do not share information and knowledge with each other, thereby raise redundant alerts to the central controller.

Further, frequent queries are made by the central controller at certain time interval; hence the centralized system is not a continuous tracking system. To continuously track of the resources in the inventory, more frequent queries are made and alerts are raised by the central controller. This increases the redundant information among the resources. Moreover, processing large amount of information is time consuming, and requires expensive computing devices.

### BRIEF DESCRIPTION OF THE FIGURES

Various embodiments of the invention will hereinafter be described in conjunction with the appended drawings provided to illustrate and not to limit the invention, wherein like designations denote like elements, and in which:

FIG. 1 is a block diagram illustrating an environment in which various embodiment of the invention may be practiced;

FIG. 2 is a block diagram illustrating a decentralized system, in accordance with some embodiments;

FIG. 3 is a flow diagram illustrating a method for processing an order request in the decentralized system, in accordance with some embodiments; and

FIG. 4 is a flow diagram illustrating a method for tracking a set of resource, in accordance with some embodiments.

### DETAILED DESCRIPTION OF THE EMBODIMENTS

Before describing in detail a method and a system for processing an order request for a set of resources in a decentralized system, in accordance with some embodiments, it should be observed that the present invention resides primarily in combinations of method steps and system components related to a technique of processing an order request. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

Various embodiments of the invention describe a method for processing an order request for a set of resources in a decentralized system. The decentralized system includes at least one operator device, and at least one pallet which is wirelessly associated with a pallet device. The method includes receiving the order request for a set of resources and obtaining resource information about them from a resource information database. Further, a pallet configuration is optimized based on the resource information. Thereafter, the pallet configuration is wirelessly communicated to the at least one pallet device and/or the at least one operator device.

Various embodiments of the invention describe a decentralized system for processing an order request for a set of resources. The decentralized system includes a server for receiving the order request, and a plurality of pallet devices such that each of the plurality of pallet devices is associated with one or more resources. Each of the plurality of pallet devices interacts with one or more of the plurality of pallet devices and with at least one of a plurality of resources. The decentralized system further includes a decentralized system device which processes the order request. The decentralized system device interacts with at least one of the plurality of pallet devices.

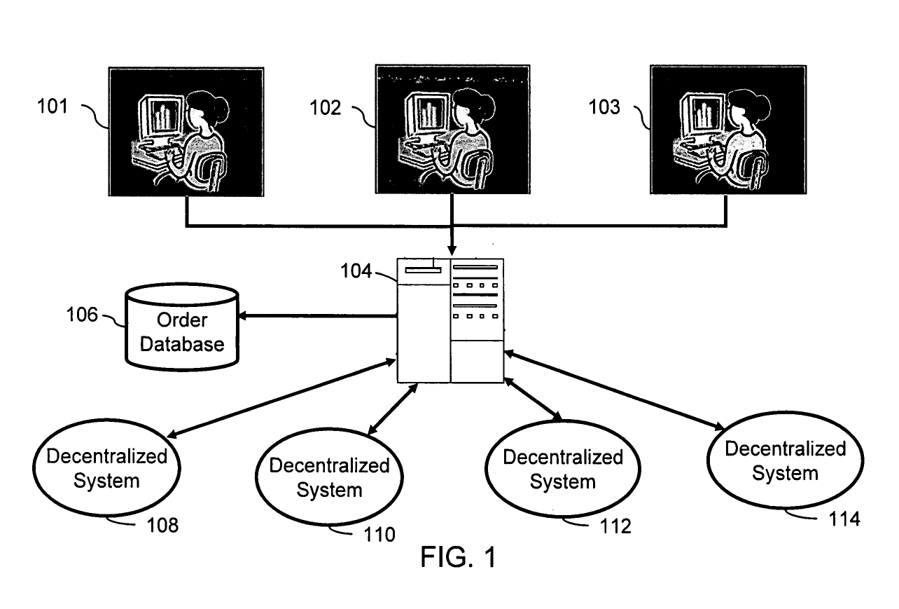

Referring to FIG. 1, a block diagram illustrates an environment where various embodiments of the invention may be practiced. The environment includes a plurality of electronic devices 101, 102, and 103, a server 104, an order database 106 and a plurality of decentralized systems 108, 110, 112, and 114. In accordance with some embodiments, the plurality of electronic devices are connected to the server 104 through a network. The network can be a wired or a wireless network. The network can also be a combination of various networks. Examples of a network include, but not limited to, a Radio Frequency Network, a Local Area Network (LAN), the Internet, a Metropolitan Area Network (MAN), and a Virtual Private Network (VPN). The server 104 interacts with the order database 106 and at least one decentralized systems.

The server 104 receives an order request for a set of resources from one or more of the plurality of electronic devices 101, 102, and 103. The electronic device 102 can be any communication device that is capable of communicating a signal from a user to the server 104. Examples of the electronic device 102 include, but are not limited to, a Mobile Phone, a Personal Digital Assistant (PDA), a Landline Phone, a Laptop Computer and a Desktop Computer. In some embodiments, the electronic devices 101, 102, and 103 are located in three different geographical regions, such as region 1, region 2 and region 3. The order request received from the electronic device 102 is logged on the order database 106 by the server 104, and directed to at least one of the plurality of decentralized systems. In accordance with some embodiments, the order request can be directed based on the location of the order request. For example, an order request for resources located in North America is directed to the decentralized system 108 located in North America.

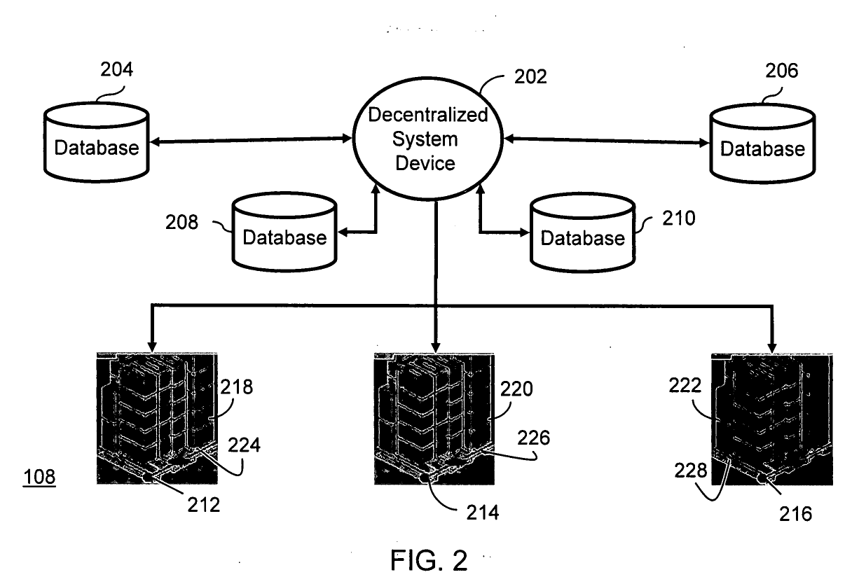

Referring to FIG. 2, a block diagram illustrates the decentralized system 108, in accordance with some embodiments. The decentralized system 108 includes a decentralized system device 202, a plurality of resource information databases, such as databases 204, 206, 208 and 210; a plurality of pallet devices, such as pallet devices 212, 214, and 216; a plurality of resources, such as resources 218, 220 and 222; and a plurality of pallets, such as pallets 224, 226 and 228.

In accordance with some embodiments, the database 204 can be a product information database; the database 206 can be an order database; the database 208 can be an inventory and receiving database; and the database 210 can be a distribution floor database. In accordance with some embodiments, the plurality of resource information databases also includes a shipping database. The decentralized system device 202 may be the server 104, or may be, for example a device that is commonly called a central controller, and may have a operator's terminal locally connected to it, or may have one of the electronic devices 101, 102, 103 locally connected to it. The decentralized system device 202 logs the order request in the order database, and queries the inventory and receiving database to check whether the set of resources are available to fulfill the order request. If the set of resources are available, the decentralized system device 202 typically allocates the set of resources to one of the distribution floor databases 204, 206, 208, 210, and updates the inventory and receiving database. After allocation of the set of resources to the distribution floor database, the decentralized system device 202 communicates with at least one of the plurality of pallet devices. One or more of the plurality of pallet devices monitor the change in the resources present in an inventory and communicates the change to other pallet devices. Examples of the change in the resources include, but are not limited to, a change in the weight of the pallet, movement of the resources, increase or decrease in the number of resources, and a change in the temperature.

In accordance with some embodiments, the decentralized system device 202 includes an operator device. The operator device is a terminal through which the user can get instructions about movement of resources. The operator device can include a display device for tracking resource location in an inventory by a user. The user can view the present state of the inventory at any given point of time by using the operator device. The present state of the inventory can include information on the availability and accessibility of the plurality of resources. The decentralized system device 202 communicates with the plurality of pallet devices, and the resource information database. The plurality of pallet devices are associated with the plurality of pallets. For example, the plurality of pallet devices 212, 214, and 216, are associated with, and communicate with, the plurality of resources 218, 220, and 222, respectively. Each of the plurality of pallets is loaded with one or more resources. For example, the resources 218, 220 and 222, are loaded on the pallets 224, 226 and 228 respectively. The resources 218, 220, and 222 communicate with pallet devices 212, 214, and 216 respectively by using a means for communication. The means for communication can be a Bluetooth means, Radio Frequency Identification (RFID) means, and so forth. In accordance with some embodiments, each of the resources is associated with one or more RFID devices. The RFID devices may store information about the respective resource. Examples of information stored by the RFID device include, but are not limited to, resource identifier, weight, volume, batch type, temperature of the resource, and so forth.

The plurality of pallet devices communicate with one or more of the plurality of pallet devices based on a set of rules. The set of rules can be based on conditions for which the plurality of pallet devices can raise alerts to the decentralized system device 202. Each of the pallet devices 212, 214, and 216, includes a memory module for storing information about the resources. The pallet devices further include a monitoring unit, and an alarming unit. The monitoring unit monitors the various parameters of resources loaded on a pallet, and the alarming unit raises alerts based on the set of rules. In accordance with some embodiments, the pallet device is also associated with a sensor. The sensors can sense physical parameters of the pallet and the resources, such as the weight, volume, and temperature of the resources loaded on the pallet, the environmental conditions, and so forth. The pallet devices can communicate with the plurality of databases, and the decentralized system device 202. The pallet devices communicate wirelessly by using communication means. Examples of communication means include, but are not limited to, an RFID means, a Bluetooth means, a Wireless Local Area Network (WLAN) means and a Global Positioning System (GPS) means.

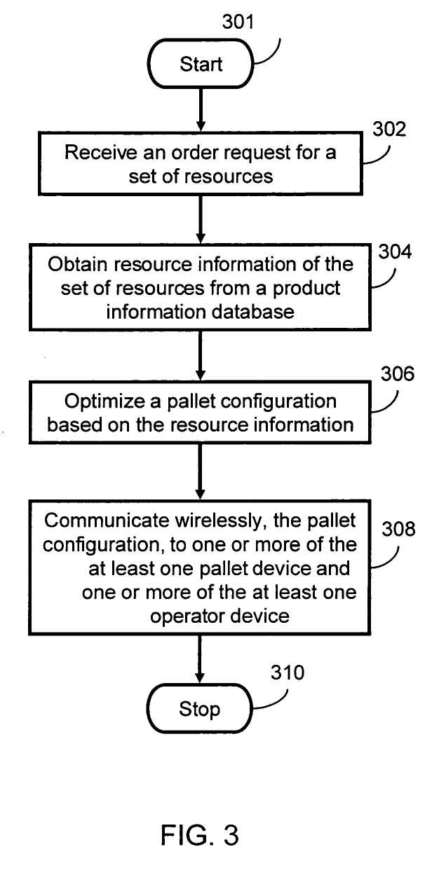

Referring to FIG. 3, a flow diagram illustrates a method for processing the order request in the decentralized system 108, in accordance with some embodiments. In some embodiments, the steps are substantially performed in a decentralized system device, such as decentralized system device 202. At step 301, the method for processing the order request in the decentralized system 108 is initiated. At step 302, the order request is received for the set of resources in the decentralized system 108. The set of resources are one or more of the plurality of resources in the decentralized system 108. The order request is updated in the order database 106 as described earlier. At step 304, resource information about the set of resources is obtained from the product information database 204. In accordance with some embodiments, the decentralized system device 202 obtains resource information for resources 218, 220, and 222 by interacting with pallet devices 212, 214, and 216.

At step 306, the pallet configuration is optimized based on the resource information. The optimization of the pallet configuration includes minimizing the cost of transportation of the set of resources and maximizing the service levels of the set of resources. The optimization is performed, based on a set of variables and a set of constraints. In accordance with some embodiments, the set of variables are mode costs, mode transfer timings, product and pallet dimensions, weights, mode penalty costs, and the order data. The mode can be a mode of shipment. Example of the set of constraints include, but are not limited to, number of modes per pallet, carrier per pallet, maximum volume of product on pallet, DIM weight compared to actual weight, and shipment arrival date. Further, the transportation of resources is optimized based on factors such as product inputs, order inputs, transportation inputs and pallet inputs. Conventional methods for these optimizations may be used. As new methods are developed, they may alternatively be used.

At step 308, the optimal pallet configuration is communicated wirelessly to at least one of the pallet devices and an operator device. The optimal pallet configuration is used at the operator device provide information to an operator for loading the pallet. The operator could be human or robotic. The optimal pallet configuration can be updated in one or more of the plurality of resource information databases. In accordance with some embodiments, a notification can be received form a pallet device that the set of resources have been removed from at least one pallet. Alternatively, the notification can be an exception notification, which is issued when an alert is raised by the pallets. At step 310, the method for processing the order request in the decentralized system 108 is terminated. The method of processing an order request may also include calculating a loading status of the resource 218 based on communication of loading parameters of one or more of the plurality of resources. The loading status may contain anticipated time of loading the pallet 224. The loading parameters can be start and end time of loading of resources on neighboring pallets. The neighboring pallets include one or more of the plurality of pallets barring pallet 224. In accordance with some embodiments, the loading parameters are communicated by the neighboring pallets to the pallet 224. Based on the communicated loading parameters the loading status is calculated by the pallet device 212 associated with the pallet 224. The method of processing an order request as described above, further includes a method for tracking the set of resources.

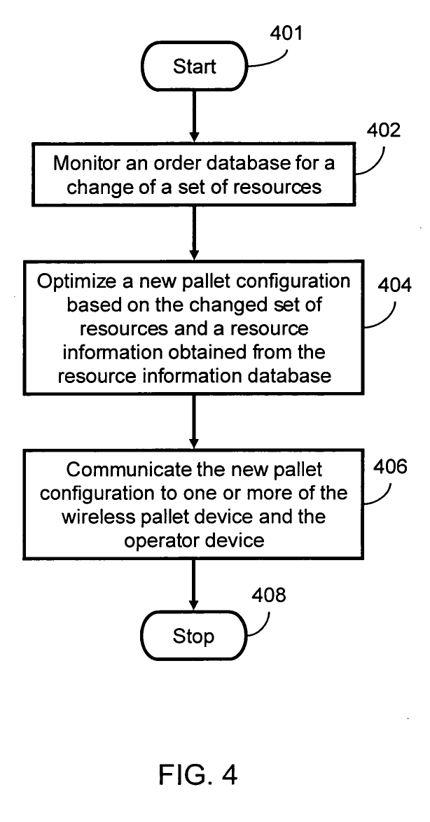

Referring to FIG. 4, a flow diagram illustrates a method for tracking the set of resources, in accordance with some embodiments. At step 401, the method for tracking the set of resources is initiated. At step 402, the resource information database is monitored for a change in the set of resources as well as in their availability and accessibility. The change in the set of resources may be a determination that a pallet is correctly loaded, or that it is correctly unloaded. In some embodiments, the change in the set of resources further includes a change in various physical parameters of the resources. A pallet is correctly loaded when it is loaded with the correct weight and dimensions of predefined resources. At step 404, a new pallet configuration is optimized based on the changed set of resources, and the resource information obtained from the resource information database. The optimization of pallet configuration includes minimizing cost of transportation of the set of resources, and maximizing service levels of the set of resources. At step 406, the new pallet configuration is communicated wirelessly to at least one pallet device and/or at least one operator device. In accordance with some embodiments, the resources 218 can be allocated to the order request based on the new pallet configuration. The resources allocated as per the order request are then shipped to the desired destination. At step 408, the method for tracking the set of resources is terminated.

In accordance with some embodiments, the pallet device 212 is reset when there is no resource present on the pallet 224 for more then a predefined period. The pallet device 214 communicates to the decentralized system device 202 that it is ready to fulfill an order request along with its location. The decentralized system device 202 fetches the next optimal pallet configuration from the shipping database that minimizes cost and maximizes service level and matches the pallet that is ready to fulfill an order. In accordance with some embodiments, the optimal configuration contains information of optimal product mix per pallet configuration, mode per pallet, ship date, destination port, address, expected arrival date and so forth. Based on location, the decentralized system device 202 communicates shipping information to a pallet device. The shipping information can contain location of resources, which will fulfill the order request.

Various embodiments, as described above, provide a method and a system for processing an order request in a decentralized system 108. This is achieved by communicating optimized pallet configuration to pallet devices. The invention provides a decentralized system that continuously tracks the resources in an inventory.

It will be appreciated that the technique of request processing in a supply chain is described herein may be comprised of one or more conventional processors and unique stored program instructions that control the one or more processors to implement some, most, or all of the functions described herein; as such, the functions of processing a request in the supply chain may be interpreted as being steps of a method. Alternatively, the same functions could be implemented by a state machine that has no stored program instructions, in which each function or some combinations of certain portions of the functions are implemented as custom logic. A combination of the two approaches could be used. Thus, methods and means for performing these functions have been described herein.

In the foregoing specification, the present invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

A “set” as used herein, means an empty or non-empty set (i.e., for the sets defined herein, comprising at least one member). As used herein, the terms “comprises,” “comprising,” “includes,” “including” or any other variation thereof, are intended to cover a non-exclusive inclusion, such that a process, method, article, or apparatus that comprises a list of elements does not include only those elements but may include other elements not expressly listed or inherent to such process, method, article, or apparatus. The term “another,” as used herein, is defined as at least a second or more. The terms “including” and/or “having,” as used herein, are defined as comprising.

What is claimed is:

1. A method for processing an order request in a decentralized system device of a decentralized system, wherein the decentralized system comprises at least one operator device and at least one pallet wirelessly associated with a pallet device, the method comprising:
receiving the order request for a set of resources;
obtaining resource information of the set of resources from a resource information database;
optimizing a pallet configuration based on the resource information; and
communicating wirelessly the pallet configuration to one or more of the at least one pallet device and one or more of the at least one operator device.

2. The method according to claim 1, further comprising:
receiving one of a notification that the set of resources have been removed from the at least one pallet and an exception notification.

3. The method according to claim 1, further comprising:
monitoring an order database for a change of the set of resources;
optimizing a new pallet configuration based on the changed set of resources and the resource information obtained from the resource information database; and
communicating the new pallet configuration to one or more of the wireless pallet devices and the operator device.

4. The method according to claim 1, wherein optimizing the pallet configuration comprises performing at least one of:
minimizing cost of transportation of the set of resources; and
maximizing service levels of the set of resources.

5. The method according to claim 4, wherein optimizing the pallet configuration comprises using a set of variables, the set of variables selected from a group comprising mode costs, mode transfer times, product dimensions, pallet dimensions, weights, mode penalty costs, and order data.

6. The method according to claim 4, wherein optimizing the pallet configuration comprises using a set of constraints.

7. The method according to claim 1, wherein communicating the pallet configuration wirelessly further comprises updating one or more databases.

8. The method according to claim 1 further comprising calculating a loading status of a resource based on communication of loading parameters.

9. The method according to claim 1, wherein communicating the pallet configuration wirelessly comprises using communication means, the communication means selected from a group comprising a Radio Frequency Identification (RFID) means, a Bluetooth means, a Wireless Local Area Network (WLAN) and a Global Positioning System (GPS) means.

10. A method for processing an order request in a decentralized system, the decentralized system comprising at least one decentralized system device and at least one pallet wirelessly associated with a pallet device, the method comprising:
receiving an order request for a set of resources;
obtaining information about the resources in the set of resources from a resource information database;
optimizing a pallet configuration based on the set of resources and the information about the resources; transmitting wirelessly the pallet configuration to a pallet device;
receiving wirelessly the pallet configuration at the pallet device;
monitoring wirelessly resources loaded onto the pallet;
making a determination that the pallet has been correctly loaded;
making a determination that the pallet has been unloaded; and
reporting the unloading to a decentralized system device.

11. The method according to claim 10, wherein optimizing the pallet configuration comprises performing at least one of:
minimizing cost of transportation of the set of resources; and
maximizing service levels of the set of resources.

12. The method according to claim 10 further comprising shipping the order request.

13. A decentralized system comprising:
a server for receiving an order request;
a plurality of pallet devices wherein each of the plurality of pallet devices is associated with one or more resources, each of the plurality of pallet devices interacting with one or more of the plurality of pallet devices and with at least one of a plurality of resources; and
a decentralized system device for processing the order request, the decentralized system device interacting with at least one of the plurality of pallet devices.

14. The decentralized system according to claim 13, wherein the decentralized system further comprises an operator device, the operator device comprising a display device for tracking resource location in an inventory to a user.

15. The decentralized system according to claim 13, further comprising at least one database, the at least one database interacting with the decentralized system device and the plurality of pallet devices.

16. The decentralized system according to claim 13, wherein each of the plurality of pallet devices interact with one or more of the plurality of pallet devices based on a set of rules.

17. The decentralized system according to claim 13, wherein at least one of the plurality of pallet devices comprises a memory module for storing information of the one or more resources.

18. The decentralized system according to claims 13, wherein each of the plurality of resources comprises a communication means, the communication means selected from a group comprising, a Radio Frequency Identification (RFID) means and a Bluetooth means.

19. The decentralized system according to claims 13, wherein each of the plurality of pallet devices comprises a communication means, the communication means selected from a group comprising an RFID means, a Bluetooth means, a Wireless Local Area Network (WLAN) and a Global Positioning System (GPS) means.

20. The decentralized system according to claim 13, wherein each of the plurality of pallet devices further comprises:
a monitoring unit for monitoring resources loaded on a pallet; and
an alarming unit for raising alerts.

21. The decentralized system according to claim 12 further comprising a plurality of sensors for sensing parameters of resources loaded on a pallet.
